(19) United States
(12) Patent Application Publication
(10) Pub. No.: US 2004/0149808 A1
(43) Pub. Date: Aug. 5, 2004

(54) Method for the adhesion of two elements, in particular of an integrated circuit, for example an encapsulation of a resonator, and corresponding integrated circuit

(75) Inventors: Guillaume Bouche, Grenoble (FR); Pascal Ancey, Revel (FR); Benoit Froment, Grenoble (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics SA, Montrouge (FR)

(21) Appl. No.: 10/729,827

(22) Filed: Dec. 5, 2003

(30) Foreign Application Priority Data
Dec. 5, 2002 (FR) 0215370

(51) Int. Cl. B23K 31/02

(52) U.S. Cl. 228/122.1

(57) ABSTRACT

A method for attaching a first element to a second element is provided. The first element has a surface portion covered with a layer of silicon, and the second element has a surface portion covered with a layer of nickel. The method includes applying pressure so that the surface portions of the first and second elements are in contact with one another. A roughness between the surface portions is less than about 1 μm, and the first and second elements are heated within a range of about 250° C. to 400° C.

### FIELD OF THE INVENTION

The present invention relates to the field of integrated circuits and microsystems, and more particularly, to the mutual adhesion of two elements of an integrated circuit or of a microsystem. The present invention advantageously applies to the encapsulation of components on an electronic chip, such as the encapsulation of a resonator supported by a Bragg mirror, for example.

### BACKGROUND OF THE INVENTION

The development of microelectronic technologies is accompanied by an increase in systematic integrations of complex electrical functions that were previously located external the package of the integrated circuit. Among these functions, mention may be made of microelectromechanical systems or MEMS and passive components known by those skilled in the art under the term “above IC” components that are produced on top of the passivation layer covering the integrated circuit.

The production of MEMS or passive components requires strict compatibility, especially thermal compatibility, in their steps with respect to the steps in producing the lower interconnect levels, as well as a protective layer before the circuit is packaged.

At the present time, the adhesion of the two elements within a microsystem is accomplished by using a polymer material for bonding. However, this approach poses a problem. Since the polymer is insulating, it does not allow an electrical contact to be made. In addition, in the case of the encapsulation of components, the use of a polymer for bonding does not allow a hermetically sealed system to be obtained.

In the field of microsystems, Patent Application WO 02/058233 discloses the encapsulation of filters using, as an adhesion, the eutectic alloy AuSi. However, this type of alloy cannot be used in microelectronics on an integrated circuit since gold would diffuse through the lower layers of the integrated circuit and damage the interconnects.

Thus, at the present time, methods do not allow the adhesion of two elements of an integrated circuit, and in particular, for encapsulating a component on an integrated circuit at an acceptable temperature, such as below 400° C. for example. This would make it possible to obtain an adhesion layer having good mechanical properties, and possibly, good electrical properties so as to obtain, for example, a hermetically or semi-hermetically sealed system.

### SUMMARY OF THE INVENTION

In view of the foregoing background, an object of the present invention is to overcome the above described problems.

This and other objects, advantages and features in accordance with the present invention are provided by a method for the adhesion of a first element, such as an integrated circuit or a microsystem for example, having at least one surface portion covered with silicon, to a second element, such as an integrated circuit or a microsystem for example, having at least one surface portion covered with nickel. The adhesion may be achieved by NiSi (nickel-silicon) bonding. The bonding may be carried out at a heating temperature above 250° C., preferably between 250° C. and 400° C., and more particularly at 300° C.

The minimum bonding time depends on the bonding temperature used and may be adjusted by those skilled in the art depending on the intended application. A minimum time of 5 minutes may be possible. However, when the temperature is below 450° C., it turns out that the minimum time may be about 20 minutes, and typically about 25 minutes. The roughness between the two surface portions of the two elements is preferably less than 1 μm. The NiSi layer thus formed may have a thickness on the order of 1 μm.

According to one variation of the invention, the second element includes, beneath the nickel layer, a silicon underlayer. The stack obtained may comprise Si/Ni/Si layers. After bonding, the stack may be formed from Si/NiSi/Si layers.

According to another variation of the invention, the first element may include, beneath the silicon layer, a nickel underlayer. The stack obtained may comprise Ni/Si/Ni layers. After bonding, this stack comprises Ni/NiSi/Si/NiSi/Ni or Ni/NiSi/Ni layers if all the silicon is consumed. This second stack has the advantage of being conductive at each of its layers.

The invention applies advantageously to the encapsulation of components on an electronic chip. In a first variation of the encapsulation method, the first element is a silicon cover, and the second element includes a resonator supported by a Bragg mirror having a nickel layer between two layers of a low acoustic impedance material, such as SiO₂ for example.

According to one implementation, the method comprises the following steps prior to the adhesion step: preparing the second element by removing a portion of the layer of low impedance material so as to expose the nickel layer; preparing the first element by forming a silicon linking portion; and bringing the linking portion of the first element into contact with the exposed portion of the nickel layer of the second element so as to obtain, after adhesion, the resonator encapsulated by the cover. The term portion means one or more regions of an element or of a layer.

According to another implementation, the first element is a silicon cover and the second element includes a resonator supported by a Bragg mirror comprising a layer of high impedance material different from nickel between two layers of a low acoustic impedance material. This method comprises, for example, the following steps prior to the adhesion step: preparing the second element by removing a portion of the layer of the low acoustic impedance material so as to expose the layer of high acoustic impedance material; depositing nickel on the exposed portion; preparing the first element by forming a silicon linking portion; and bringing the linking portion of the first element into contact with the exposed portion of the nickel layer of the second element so as to obtain, after adhesion, the resonator encapsulated by the cover.

Another aspect of the present invention is directed to a device, such as an integrated circuit or a microsystem for example, comprising at least two elements mutually fastened by a bond formed by a NiSi alloy.

According to a first variation of the device, the two mutually fastened elements may be made of silicon. According to a second variation of the device, the two mutually fastened elements may be made of nickel.

According to yet a third variation of the device, the first element may be a silicon cover and the second element may be a resonator supported by a Bragg mirror. The layer of high acoustic impedance material may be nickel. The NiSi bond may be located at the interface between a region of the cover and a portion of the nickel layer, and the resonator may be encapsulated by the cover.

According to a fourth variation of the device, the first element may also be a silicon cover and the second element may also be a resonator supported by a Bragg mirror. The layer of high impendence material may be different from nickel. The NiSi bond may be located at the interface between a region of the cover and a portion of the layer of high acoustic impedance material, and the resonator may be encapsulated by the cover.

### BRIEF DESCRIPTION OF THE DRAWINGS

Other advantages and features of the present invention will become apparent on examining the detailed description of entirely non-limiting embodiments and methods of implementation, together with the appended drawings in which:

FIGS. 1 and 2 illustrate, very schematically, a first implementation resulting in a first embodiment of an integrated circuit according to the present invention;

FIGS. 3 and 4 illustrate, very schematically, a second implementation resulting in a second embodiment of an integrated circuit according to the present invention;

FIGS. 5 to 10 illustrate, very schematically, another implementation of the method according to the present invention, that is more particularly suited for encapsulation of a resonator supported by a Bragg mirror; and

FIGS. 11 to 15 illustrate, again very schematically, another implementation of the method according to the present invention, that is more particularly suited for encapsulation of a resonator supported by a Bragg mirror.

### DETAILED DESCRIPTION OF THE PREFERRED EMBODIMENTS

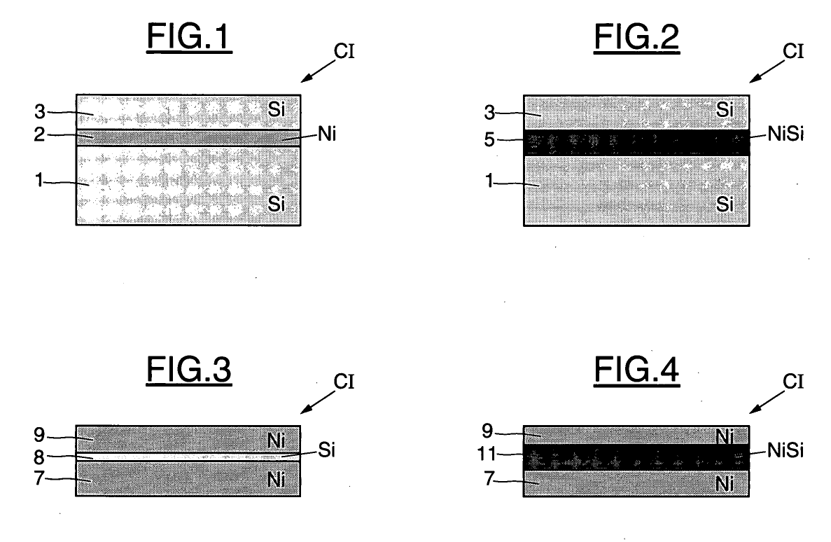

FIG. 1 shows a silicon layer 1 of an integrated circuit IC, on which a nickel layer 2 has been deposited. Another silicon layer 3 has been deposited on or brought into contact with the nickel layer 2.

FIG. 2 shows the same elements as those shown in FIG. 1 once the bonding has been carried out. Thus, two silicon layers 1 and 3 that adhere to each other by a NiSi (nickel-silicon) bond 5 are obtained.

In FIG. 3, the integrated circuit IC this time includes a thin silicon layer 8 placed between two nickel layers 7 and 9. After bonding (FIG. 4), the two nickel layers 7 and 9 are mutually fastened by the NiSi alloy 11. In this implementation, since the NiSi alloy is conductive, the stack of the layers 7, 11 and 9 has the advantage of being electrically conductive in the vertical direction. This embodiment therefore makes it possible to fasten two nickel elements of an integrated circuit and to produce an electrically conductive stack, which could, for example, serve as an electrical interconnect.

In general, the bonding according to the invention is carried out at a temperature above 250° C., preferably between 250° C. and 400° C., and more particularly at 300° C. To carry out the bonding of two elements, the two elements are kept in contact, typically for 25 minutes, with each other with sufficient pressure to ensure that they are heated to the bonding temperature. Moreover, the roughness of the layers to be bonded is a parameter that allows a strong, reliable and vacuum-tight bond to be obtained. The assembly forms a second element intended to be fastened by NiSi bonding to a first element of an integrated circuit. A roughness less than or equal to 1 μm is preferable. The thickness of the NiSi layer obtained depends on the thickness of the layers that are present and on the bonding time. For example, a thickness of about 1 μm is an acceptable value for a bond.

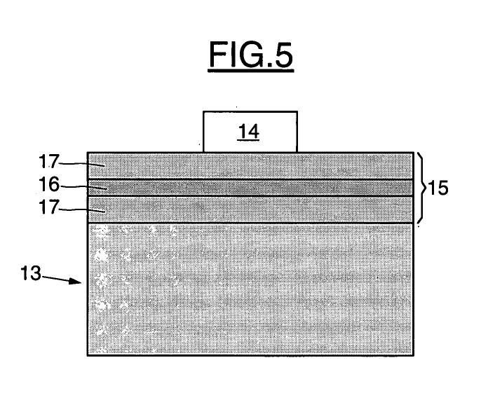

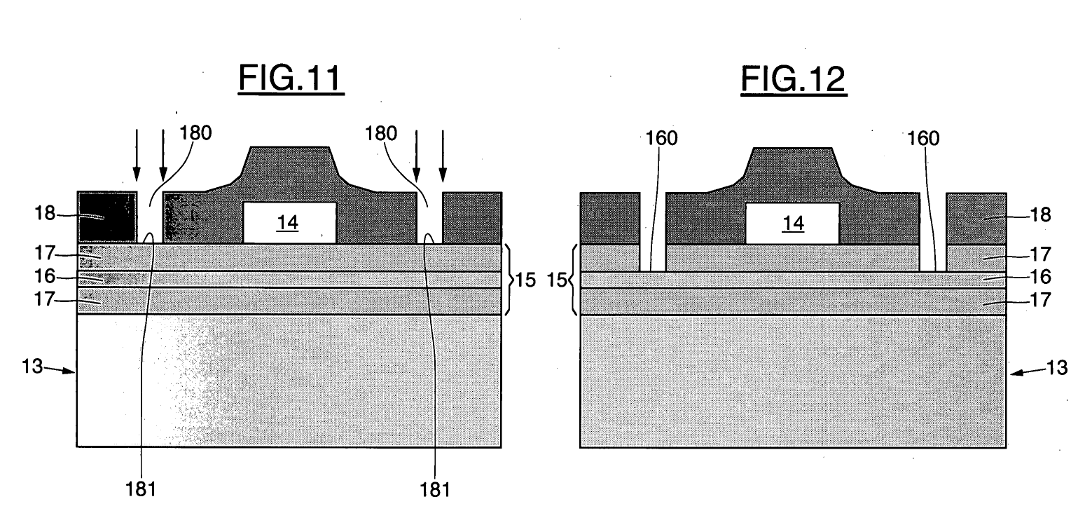

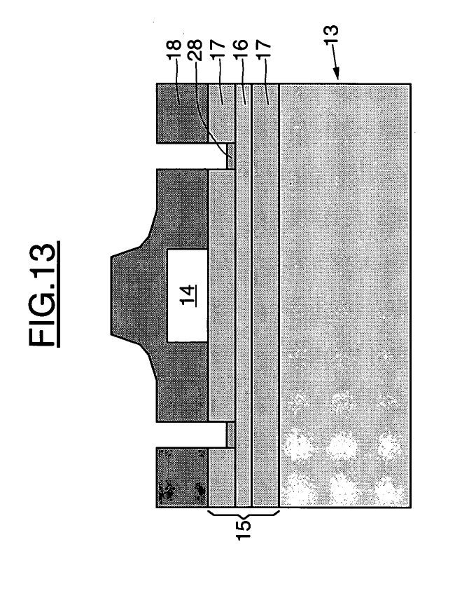

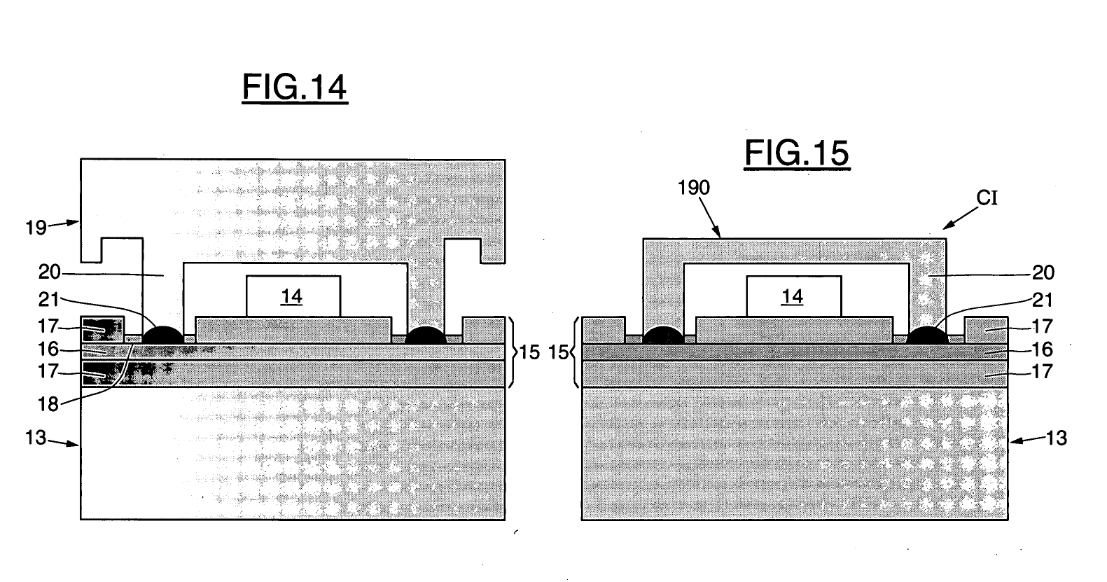

One particular application of NiSi bonding according to the invention, namely the encapsulation of a component such as a resonator supported by a Bragg mirror, will now be described with reference to FIGS. 5 to 15. A first variation of this method of encapsulation is illustrated in FIGS. 5 to 10.

FIG. 5 shows an element, called a second element, which comprises a resonator 14 supported by a Bragg mirror 15, and formed from a nickel layer 16 located between two layers 17 of a low acoustic impedance material, for example SiO₂. This second element, supported by a substrate 13, will undergo preparation steps prior to the adhesion step.

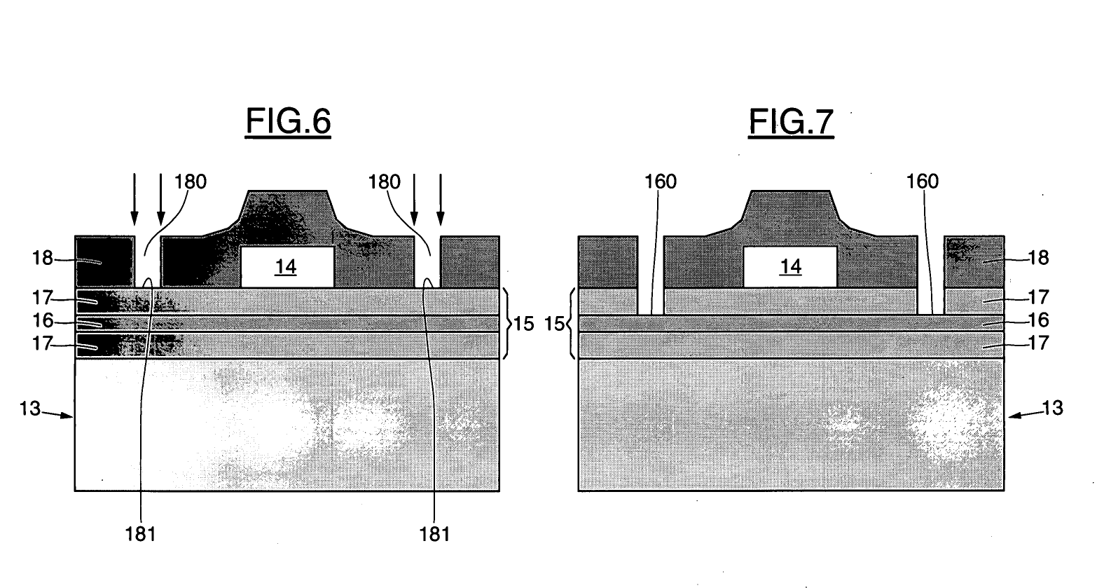

FIG. 6 shows the second element on which a resist 18 has been deposited so as to protect the resonator 14 from the subsequent treatments. Next, two openings 180 are chemically etched in the resist 18 to expose two regions 181 of the upper surface of the Bragg mirror.

FIG. 7 shows the second element, once a portion of the layer 17 of the low acoustic impedance material has been removed from the regions 181, such as by an ion process or by selective etching for example. The actual characteristics of which depend on the material used. The nickel layer 16 of the Bragg mirror is then exposed in the regions 160. These exposed nickel regions 160 will then be able to undergo an optional plasma cleaning step to remove the silica residues that may have been introduced during the etching. This is preferable for obtaining a clean nickel surface.

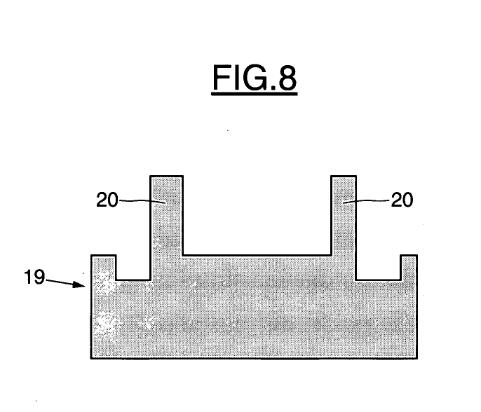

FIG. 8 shows a first silicon element 19 in which a silicon linking portion 20 has been produced by etching. Before the first and second elements are brought into contact, the resist 18 that protects the resonator of the second element is removed from the surface of the Bragg mirror 15.

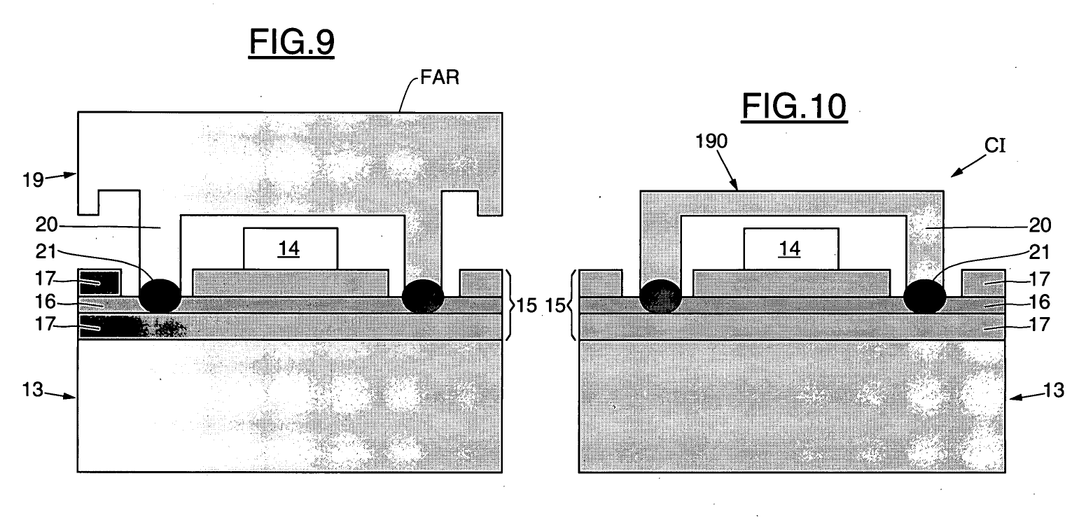

The linking portion 20 of the first element 19 is then brought into contact with the exposed nickel regions 160 of the second element (FIG. 9). Next, the bonding process is carried out to form a NiSi alloy 21 at the interface between the silicon linking portion 20 and the nickel regions 160. The thickness of the bond is, for example, 1 μm.

The encapsulation obtained may be carried out in a vacuum or under low pressure to obtain a hermetically or semi-hermetically sealed package. When the vacuum is created before the bonding step, the bonded joint will be formed under vacuum. Next, as illustrated in FIG. 10, the rear face F_{REAR} of the element 19 undergoes, for example, chemical-mechanical polishing to form a silicon cover 190.

The integrated circuit IC thus obtained then comprises a substrate 13 having, on its upper portion, a Bragg mirror 15 formed from a stack of layers, only the last three of which are shown in FIG. 10. The layer 16 of high acoustic impedance is formed from nickel and is sandwiched between two layers of low acoustic impedance, for example SiO₂ layers. The Bragg mirror 15 supports a resonator 14 that is encapsulated between the Bragg mirror and a silicon cover 190. The Bragg mirror 15 and the silicon cover 190 are fastened together by a bond 21 formed from a NiSi alloy. This alloy is located at the interface between the nickel layer 16 of the Bragg mirror and the linking portions 20 of the cover.

The second variation of the method is illustrated in FIGS. 11 to 15. Only the differences between these figures and FIGS. 5 to 10 will now be described. According to this second variation, the Bragg mirror 15 has a layer 16 of a high acoustic impedance material, different front nickel. This layer 16 may, for example, be made of copper, aluminum, tungsten, molybdenum or any other conductive metal.

After having exposed the regions 160 of the layer 16, a layer of nickel 28 is deposited, for example by electrolytic deposition, on these regions 160. Next, the bonding process is carried out after the linking portion 20 of the element 19 has been brought into contact with the nickel layers 28. Here again, the thickness of the nickel layer 28 is chosen to obtain a NiSi bond 21 with a thickness of 1 μm for example.

The rest of the process is identical to that described above with reference to FIG. 10. As illustrated in FIG. 15, an integrated circuit similar to that of FIG. 10 is obtained, except that, this time, the cover 190 encapsulates a resonator supported by a Bragg mirror whose layer of high acoustic impedance is not made of nickel. Even though the entire NiSi bond may consume all of the nickel layer 28, it is also possible, depending on the thicknesses used, for a residue of nickel 28 to remain beneath the NiSi bond 21.

Although an application of the invention relating to elements of an integrated circuit has been described, the NiSi bonding according to the invention may also apply to microsystems, and therefore advantageously replaces bonding with the eutectic alloy AuSi.

That which is claimed is:

1. Method for the adhesion of a first element, at least one portion of the surface of which is covered with silicon, to a second element, at least one portion of the surface of which is covered with nickel, comprising an adhesion step carried out by NiSi bonding at a heating temperature above 250° C., the roughness between the two surface portions of the two elements being less than 1 μm.

2. Method according to claim 1, characterized in that each of the two elements forms part of an integrated circuit of a microsystem.

3. Method according to claim 1 or 2, characterized in that the minimum bonding time is at least 5 minutes.

4. Method according to one of claims 1 to 3, characterized in that the heating temperature is between 250° C. and 400° C., preferably 300° C.

5. Method according to claims 3 and 4, characterized in that the minimum bonding time is at least 20 minutes, for example 25 minutes.

6. Method according to one of the preceding claims, characterized in that the layer formed from NiSi has a thickness of the order of 1 μm.

7. Method according to one of the preceding claims, characterized in that the second element includes, beneath the nickel layer, a silicon underlayer.

8. Method according to one of claims 1 to 6, characterized in that the first element includes, beneath the silicon layer, a nickel underlayer.

9. Method according to any one of claims 1 to 6, in which:
the first element is a silicon cover; and
the second element includes a resonator supported by a Bragg mirror having a nickel layer between two layers of low acoustic impedance material, characterized in that this method comprises the following steps prior to the adhesion step:
a step of preparing the second element, comprising the removal of at least a portion of the layer of low acoustic impedance material so as to expose the nickel layer;
a step of preparing the first element, comprising the formation of at least a silicon linking portion; and
a step of bringing the linking portion of the first element into contact with the exposed portion of the nickel layer of the second element;
so as to obtain, after adhesion, the resonator encapsulated by the cover.

10. Method according to any one of claims 1 to 6, in which:
the first element is a silicon cover; and
the second element includes a resonator supported by a Bragg mirror comprising a layer of high acoustic impedance material different from nickel between two layers of low acoustic impedance material, characterized in that this method comprises the following steps prior to the adhesion step:
a step of preparing the second element, comprising the removal of at least a portion of the layer of low impedance material so as to expose the layer of high impedance material;
a step of forming nickel on the exposed portion;
a step of preparing the first element, comprising the formation of at least a silicon linking portion; and
a step of bringing the linking portion of the first element into contact with the nickel layer formed on the second element;
so as to obtain, after adhesion, the resonator encapsulated by the cover.

11. Integrated circuit, characterized in that it comprises at least two elements mutually fastened by a bond formed from an NiSi alloy.

12. Integrated circuit according to claim 11, characterized in that the two elements are made of silicon.

13. Integrated circuit according to claim 11, characterized in that the two elements are made of nickel.

14. Integrated circuit according to claim 11, characterized in that the first element is a silicon cover and the second element is a resonator supported by a Bragg mirror, the layer of high impedance material of which is nickel, the NiSi bond being located at the interface between a region of the cover and a portion of the nickel layer, the resonator being encapsulated by the cover.

15. Integrated circuit according to claim 11, characterized in that the first element is a silicon cover and the second element is a resonator supported by a Bragg mirror, the layer of high impendence material of which is different from nickel, the NiSi bond being located at the interface between a region of the cover and a portion of the layer of high impedance material, the resonator being encapsulated by the cover.
